(19) United States
(12) Patent Application Publication
(10) Pub. No.: US 2023/0400368 A1
(43) Pub. Date: Dec. 14, 2023

(54) Sensor

(71) Applicant: InnovationLab GmbH, Heidelberg (DE)

(72) Inventors: Christoph Kaiser, Kirkel Limbach (DE); Janusz Schinke, Ludwigshafen (DE)

(21) Appl. No.: 18/032,293

(22) PCT Filed: Oct. 19, 2021
(86) PCT No.: PCT/EP2021/078935

§ 371 Date: Apr. 17, 2023

(30) Foreign Application Priority Data
Oct. 19, 2020 (LU) LU102131

(51) Int. Cl. G01L 1/18

(52) U.S. Cl. CPC G01L 1/18

(57) ABSTRACT

A sensor measuring forces, a method for manufacturing a sensor and a method for measuring a force are disclosed. The sensor comprises a first substrate and a second substrate arranged at a distance in a planar manner from each other. A plurality of first electrodes is disposed apart from each other at a first distance on an inner side of the first substrate and a plurality of force-sensitive elements arranged on the inner side of the first substrate and covers at least a part of individual ones of the plurality of first electrodes. A second electrode is arranged on an inner side of the second substrate and extends across at least ones of the plurality of the force-sensitive elements. The second electrode of the second substrate is thereby in direct contact with the plurality of force-sensitive elements of the first substrate.

### CROSS-REFERENCE TO RELATED APPLICATIONS

This application is a national phase entry of international patent application No. PCT/EP2021/078935 filed on 19 Oct. 2021 claiming priority of Luxembourg Patent Application number LU102131, filed on 19 Oct. 2020. The foregoing applications are hereby incorporated herein by reference in their entirety.

### BACKGROUND OF THE INVENTION

### Field of the Invention

The present invention relates to a homogenized and highly sensitive sensor which uses piezoresistive effects for measuring a force.

### Brief Description of the Related Art

Piezoresistive force measuring sensors are known in the art and are built commonly with force-sensitive resistors (FSRs) either in thru-mode or in shunt-mode. Shunt-mode FSRs are more sensitive to a broader range of forces and are the most frequently used design of force sensing resistors. Thru-mode FSR's are more sensitive to weaker forces and the sensitivity is broader than that of shunt-mode FSRs. A further difference between the shunt-mode and in the thru-mode is that in the shunt-mode inlet electrodes and outlet electrodes are both located on the same substrate while in thru-mode the inlet electrodes and the outlet electrodes are separated on two different substrates.

European Patent Application EP 3 237 865 A1 and the corresponding US Patent Application US 2017 350 772 A1 teaches, for example, a piezoresistive device and a pressure sensor incorporating such a piezoresistive device. The piezoresistive device requires only a single type of substrate to be produced, in which the substrate comprises a first layer of piezoresistive ink positioned between an upper conductive layer and a lower conductive layer covered by a second layer of piezoresistive ink in the thru-mode. The piezoresistive material ink comprises carbon nanoparticles dispersed in a polymer matrix material as isolation material between adjacent conductive traces. The patent application includes plots showing the effect of the number of layers of piezoresistive ink on a measured resistance and logarithmic plots showing measured resistance versus applied force for devices incorporating the piezoresistive ink with different loadings of carbon nanoparticles.

US Patent Application Publication No. US 2015 091 857 A1 discloses a system for detecting a pressure. A touch sensor detector system and method incorporating an interpolated sensor array is disclosed. The system and method utilize a touch sensor array configured to detect proximity/contact/pressure via a variable impedance array electrically coupling interlinked impedance columns coupled to an array column driver, and interlinked impedance rows coupled to an array row sensor. The system incorporates a few components and uses interpolation of sensed current/voltage which allows detection of the touch sensor array proximity/contact/pressure and/or spatial location.

US Patent Application US 2006 147 700 A1 discloses a pressure sensitive device that provides a stable response to measure an applied force at temperatures greater than 150° F. (around 66° C.). The pressure sensitive device has a conductivity of about 0.01 muS to about 1300 muS and a sensitivity of about 0.01 muS/lb to about 300 muS/lb (about 0.02 muS/kg to about 660 muS/kg) at about a temperature range of about −50° F. to over about 400° F. or 420° F. (about −45° C. to over about 205° C. or 216° C.). The pressure sensitive device has a substrate of polyimide, conductive leads of silver dispersed in a polyhydroxy ether crosslinked with melamine formaldehyde, and a pressure sensitive layer of carbon nanoparticles dispersed in cured polyamic acid forming a polyimide.

International patent application WO 2011/078164 A1 discloses a pressure-sensitive sensor with an external force calculation means which holds normalized information relating to “external force-resistance characteristic” that is normalized on the basis of a predetermined numerical expression using a resistance value when the set maximum external force of a pressure-sensitive ink member is added, a resistance value when no external force is added, and a resistance value when external force less than the set maximum external force is added.

Developments in the field of electronics and electronic applications raise the need for sensors with higher sensitivity to make applications and processes more accurate and precise. There is therefore a need for force sensors which are highly sensitive also to weaker forces which are used in different electronic devices such as e.g., high-precision measuring devices, i.e., able to sense a low level of a force and/or pressure applied to the sensor.

### SUMMARY OF THE INVENTION

The present document teaches a highly sensitive sensor, a method of manufacturing of such a sensor and a method of measuring a very small force applied to said sensor.

The sensor comprises a first substrate and a second substrate arranged in a planar manner separated from each other with a plurality of first electrodes disposed apart from each other at a first distance on an inner side of the first substrate, a plurality of force-sensitive elements arranged on the inner side of the first substrate and covering at least a part of individual ones of the plurality of first electrodes, and a second electrode arranged on an inner side of the second substrate and extending across at least ones of the plurality of the force-sensitive elements. The second electrode of the second substrate is in direct contact with the plurality of force-sensitive elements of the first substrate.

In an aspect, the plurality of force-sensitive elements can be arranged on the inner side of the second substrate and cover at least a part of the second electrode, wherein the force-sensitive elements are arranged in such a way that the force-sensitive elements cover the plurality of first electrodes. The force-sensitive elements of the second substrate are arranged in such a way that the force-sensitive elements cover the plurality of first electrodes of the first substrate upon assembly of the first substrate with the second substrate and the plurality of first electrodes of the first substrate are in direct contact with the plurality of force-sensitive elements of the second substrate.

In another aspect the first distance between the first electrodes is such that the plurality of force-sensitive elements is spaced apart from each other. This isolates the first electrodes from each other.

In a further aspect the plurality of first electrodes is disposed substantially parallel to each other. In another aspect, the plurality of first electrodes is disposed at an angle to each other or using other geometries. Interferences between parallel electrodes are decreased and the sensitivity of the sensor is increased.

In a further aspect the plurality of first electrodes comprises a first set of electrodes and a second set of electrodes. The first set of electrodes and the second set of electrodes are arranged in an alternating manner. In this configuration a positive electrode and a negative electrode are arranged alternating along the inner side of the first substrate.

A method for manufacturing a sensor is also disclosed. The method comprises providing a substrate divided into a first substrate and a second substrate; printing of a first set of first electrodes and a second set of first electrodes on the first substrate; printing a second electrode extensively on the second substrate; printing a plurality of force-sensitive elements on the first set of first electrodes; folding the substrate such that the first substrate and the second substrate are substantially concentric; and cutting the folded substrate (K) to obtain the sensor. This method enables manufacturing of the sensor at a low cost with a reduced amount of raw materials. In addition, both the first substrate and the second substrate can be manufactured individually which leads to a high variety of sensor designs.

In a first aspect, the method further comprises providing the first substrate and the second substrate as a common substrate, folding the common substrate such that the first substrate and the second substrate are substantially aligned, and cutting the folded common substrate to obtain the sensor.

In a further aspect an isolation material is provided on a part of the first set of electrodes and the second set of first electrodes, which is not covered by the plurality of force-sensitive elements. The isolation material isolates the first electrodes from the second electrodes.

The document also discloses a method for measuring a force applied to a sensor, wherein the method comprises: applying a voltage to cause an electric current to flow from a first set of a plurality of first electrodes in a direction substantially perpendicular to a top surface of said first set of the plurality of first electrodes through a first set of a plurality of force-sensitive elements to a second electrode, across the second electrode, and through a second set of the plurality of force-sensitive elements to a second set of the plurality of first electrodes in a direction which is substantially perpendicular to a top surface of said second set of the plurality of first electrodes; applying the force to the sensor and thus changing an electrical resistance of the first set of the plurality of force-sensitive elements of the sensor and the second set of the plurality of force-sensitive elements of the sensor; and determining, using an electrical measuring device, a change of electrical resistance of the sensor and thereby determining the amount of the applied force.

The determination of the change of electrical resistance of the sensor is obtained by one of a determination of a current-change or determination of a change of electrical resistance of a comparator resistor. The comparator resistor is part of an electrical circuit such as for example an operational amplifier or a Wheatstone bridge.

### BRIEF DESCRIPTION OF THE DRAWINGS

FIG. 1 is an exploded cross-sectional view of a sensor.

FIG. 2 shows one part of the sensor seen from above.

FIG. 3 shows the sensor in a second view from above.

FIG. 4 shows another aspect of the sensor in a view from above.

FIG. 5 is an exploded cross-sectional view of the sensor in operation with an applied force.

FIG. 6 shows a diagram with measuring results of the force applied to the sensor.

### DETAILED DESCRIPTION OF THE INVENTION

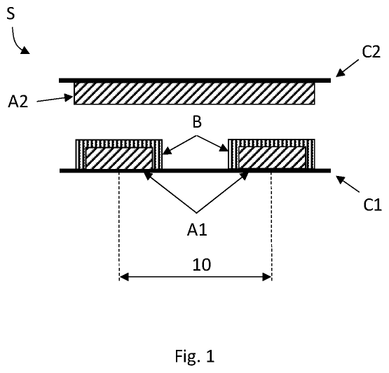

FIG. 1 shows an exploded cross-sectional view of a sensor S. The sensor S comprises a first substrate C1 and a second substrate C2 arranged in a planar manner at a distance from each other. The first substrate C1 and the second substrate C2 are made, for example, from Kapton, Polyimide PI, Polyethylene-naphthalate PEN, Polyethylene-terephthalate PET, Thermoplastic-polyurethane TPU, Polyurethane PU, Mica, flexible glass, Fleece, Polyether-ether-ketone PEEK, but this is not limiting of the invention.

A plurality of first electrodes A1 is disposed parallel and spaced apart from each other at a first distance 10 on an inner side of the first substrate C1. The plurality of first electrodes A1 are made, for example, from a conductive material, such as silver, copper, carbon, gold, PEDOT or indium-tin-oxide ITO, but this is not limiting of the invention.

A plurality of force-sensitive elements B are arranged on the inner side of the first substrate C1 and are covering at least a part of individual ones of the plurality of first electrodes A1. The plurality of force-sensitive elements B are made, for example, from one of a carbon-based force-sensitive resistor material, percolating materials consisting of a conductive species and a non-conductive species (e.g., carbon/polymer guest host systems), but this is not limiting of the invention.

A second electrode A2 is arranged on an inner side of the second substrate C2. The second electrode A2 extends across the at least one of the plurality of the force-sensitive elements B. In other words, the plurality of the force-sensitive elements B is covered by the second electrode A2. The second electrode A2 is made, for example, from a conductive material, such as silver, copper, carbon, gold, PEDOT or indium-tin-oxide ITO, but this is not limiting of the invention, but this is not limiting of the invention.

With such a design, the plurality of first electrodes A1 are electronically separated from each other as well as separated from the second electrode A2 by the plurality of force-sensitive elements B. Thus, the design of the sensor S combines the thru-mode design and the shunt-mode design. The design of the sensor S in FIG. 1 allows the plurality of first electrodes A1 to be arranged such that inlet electrodes and outlet electrodes of the plurality of first electrodes A1 are located at the first substrate C1 (see shunt-mode). However, the sensor S is more receptive to lighter forces and more linear than that of shunt-mode, as presented below.

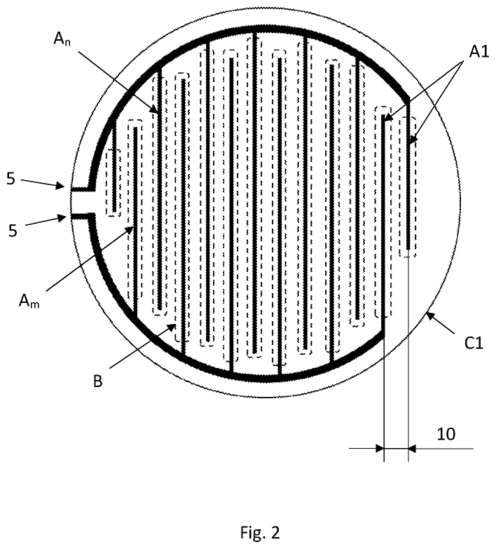

FIG. 2 illustrates one part of the sensor S as seen from above. The first electrodes A1 are divided into a first set Aₘ of electrodes and a second set Aₙ of electrodes. The first set Aₘ of electrodes and the second set Aₙ of electrodes are arranged on the first substrate C1 in an alternating manner. The first set Aₘ of electrodes and the second set Aₙ of electrodes are connected each to a contact 5. The sensor S can be connected to an external device via the contacts 5. The first set Aₘ of electrodes may be a positive electrode and the second set Aₙ of electrodes may be a negative electrode or optionally the first set Aₘ of electrodes may be a negative electrode and the second set Aₙ of electrodes may be a positive electrode. Thus, the sensor S is not limited to a positive and/or negative connection arrangement at the contacts 5.

The force-sensitive elements B are covering at least a part of individual ones of the plurality of first electrodes A1 and are arranged with the first distance 10 from each other such that the force-sensitive elements B do not touch each other. The force-sensitive elements B comprise a force-sensitive material which changes its electrical resistance in relation to an applied force F or pressure.

The first distance 10 has typically a value bigger than 0 millimeters but smaller than 0.5 millimeters, but this is not limiting of the invention. In one non-limiting aspect the first distance 10 has a value between 0.05 millimeters and 10 centimeters. In another aspect, for special applications, the first distance 10 can have a value greater than 10 centimeters.

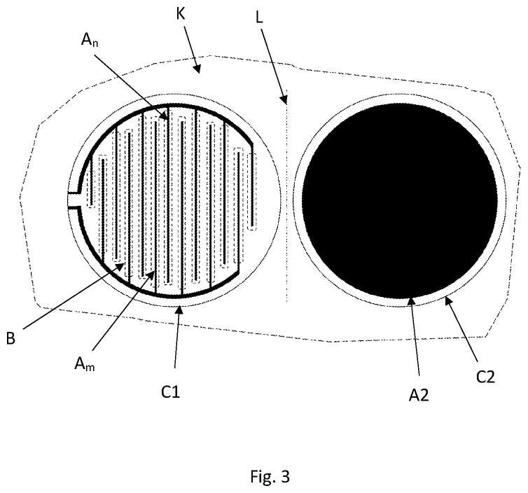

FIG. 3 shows the sensor S from above during the manufacturing process. A substrate K is divided into the first substrate C1 and the second substrate C2. The substrate K can be chosen from any suitable, non-conductive material. Preferably, the substrate K is chosen, for example, from Kapton, Polyimide PI, Polyethylene-naphthalate PEN, Polyethylene-terephthalate PET, Thermoplastic-polyurethane TPU, Polyurethane PU, Mica, flexible glass, Fleece, Polyether-ether-ketone PEEK, but this is not limiting of the invention.

In a first aspect, a fold-line L marks a symmetrical distance between the first substrate C1 and the second substrate C2. The plurality of first electrodes A1 is printed on the first substrate C1. The second electrode A2 is printed extensively on the second substrate C2. After the force-sensitive elements B are printed on the first set Aₘ of electrodes A1 and on the second set Aₙ of first electrodes A1, an isolation material can be provided on a part of the first set Aₘ of electrodes A1 and the second set Aₙ of first electrodes A1, which is not covered by the plurality of force-sensitive elements B. Thus, the plurality of first electrodes A1 does not have direct contact with the second electrode A2 when assembled.

After all layers of the sensor S are manufactured, the substrate K can be folded along the fold-line L. The fold-line L serves only as an orientation when folding the substrate K such that the first substrate C1 and the second substrate C2 are folded together substantially aligned. After the folding the substrate K can be cut to get the desired shape of the sensor S. The sensor S can have any shape. In one aspect, the shape of the sensor S is circular and the first substrate C1 and the second substrate C2 are aligned substantially concentric.

In another aspect, the first substrate C1 and the second substrate C2 do not necessarily originate on the same substrate K. In other words, the first substrate C1 with the plurality of first electrodes A1 and the plurality of force-sensitive elements B can be manufactured separate from the second substrate with the second electrode A2.

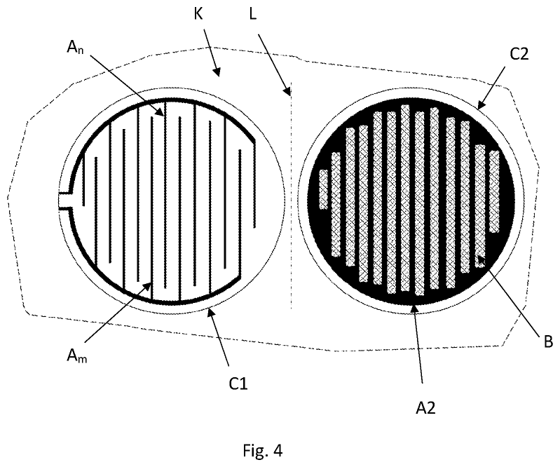

FIG. 4 shows another aspect of the sensor in which the force-sensitive element B can be printed on the first electrodes A1 on the first substrate C1 as well as on the second electrode A2 on the second substrate C2. In this aspect of FIG. 4, the force-sensitive element B covers entirely the second electrode A2 on the second substrate C2.

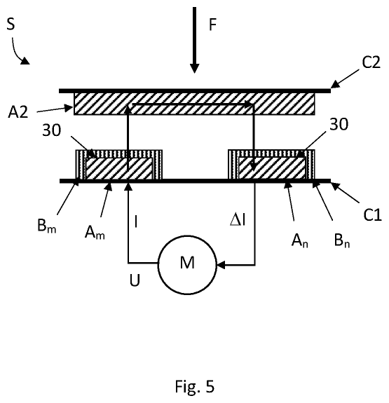

FIG. 5 shows an exploded view of the sensor S in operation. In the illustrated, non-limiting example, the sensor S is connected to an electric circuit via the contacts 5 and a voltage U is applied. The voltage U causes an electric current I to flow, for example, from the first set Aₘ of the plurality of first electrodes A1 in a direction substantially perpendicular to a top surface 30 of said first set Aₘ of the plurality of first electrodes A1 through a first set Bₘ of a plurality of force-sensitive elements B to the second electrode A2. The current I flows then across the second electrode A2 and through a second set Bₙ of the plurality of force-sensitive elements B to a second set Aₙ of the plurality of first electrodes A1 in a direction which is substantially perpendicular to a top surface 30 of said second set Aₙ of the plurality of first electrodes A1.

When the force F or a pressure is applied to at least one of the first substrate C1 and the second substrate C2, the force-sensitive material of the first set Bₘ of the plurality of force-sensitive elements B and the second set Bₙ of the plurality of force-sensitive elements B change their electrical resistance and the amount of electric current I through the sensor S between the contacts 5 changes in accordance with the applied force F. A current change ΔI of the electrical current I (see FIG. 5) or a change of electrical resistance of a comparator resistor in a measuring device M (not shown) can be determined with the measuring device M and thus the amount of the applied force F is determined. In other words, the current-change ΔI of the current I through the sensor S or a change of electrical resistance of the comparator resistor in the measurement device M relate to the change of the electrical resistance in the force-sensitive elements B which is relative to the applied force F or pressure which can be determined with the measuring device M.

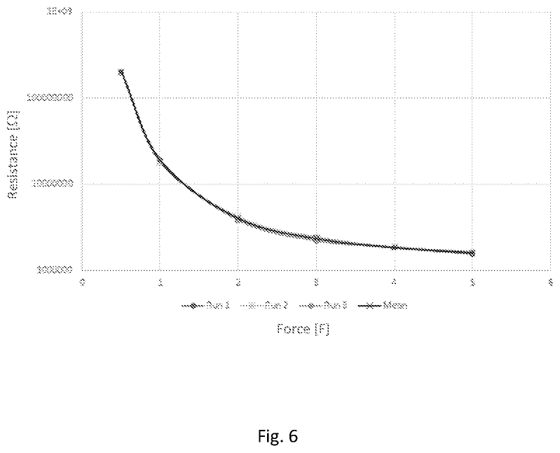

FIG. 6 shows a diagram demonstrating the sensitivity of the sensor S. The sensor S was manufactured according to the method outlined in FIG. 4. In this non-limiting example, the measured sensor S has a circular shape with a diameter of 5 mm. The sensor S has thus a surface of approximately 20 mm². The force F acting on the first substrate C1 of the sensor S was applied constantly with a range starting at 0.5 Newtons up to 5 Newtons. A change, i.e., increase or decrease of the electrical resistance of the plurality of force-sensitive elements B was determined either via the measured current-change ΔI of the electrical current I through the sensor S or a change of electrical resistance of a comparator resistor (not shown in the Figs.). The measurement was repeated three times and a mean value of the measurement result was calculated.

As seen in the diagram of FIG. 6, the sensor S is capable of repeatedly determining very weak forces F of 0.5 Newtons to 5 Newtons. Compared to the sensor of EP 3 237 865 A1, the sensitivity of the sensor S is around twenty times higher.

As shown in the diagram, the electrical resistance is plotted by a logarithmic scale on the ordinate. The applied force F is plotted linear on the abscissa. It can be easily seen that the disclosed sensor S is capable to sense repeatedly a resistance in a range of more than 100 MΩ (Megaohm) to 1 MΩ with the applied force F in the above-mentioned range.

1. A sensor comprising:
a first substrate and a second substrate arranged in a planar manner at a distance from each other;
a plurality of first electrodes disposed apart from each other at a first distance on an inner side of the first substrate;
a plurality of force-sensitive elements arranged on the inner side of the first substrate and covering at least a part of individual ones of the plurality of first electrodes;
a second electrode arranged on an inner side of the second substrate and extending across at least ones of the plurality of the force-sensitive elements;
wherein the second electrode of the second substrate is in direct contact with the plurality of force-sensitive elements of the first substrate.

2. A sensor comprising:
a first substrate and a second substrate arranged in a planar manner at a distance from each other;
a plurality of first electrodes disposed apart from each other at a first distance on an inner side of the first substrate;
a second electrode-arranged extensively on an inner side of the second substrate;
a plurality of force-sensitive elements arranged on the inner side of the second substrate and covering at least a part of the second electrode,
wherein the force-sensitive elements of the second substrate are arranged in such a way that the force-sensitive elements cover the plurality of first electrodes of the first substrate upon assembly of the first substrate with the second substrate, and wherein
the plurality of first electrodes of the first substrate are in direct contact with the plurality of force-sensitive elements of the second substrate.

3. The sensor according to claim 1, wherein
the first distance between the plurality of first electrodes is such that the plurality of force-sensitive elements are spaced apart from each other.

4. The sensor according to claim 1, wherein
the plurality of first electrodes are disposed substantially parallel to each other, at an angle to each other or using other geometries.

5. The sensor according to any one of claim 1, wherein
the plurality of first electrodes comprises a first set and a second set of electrodes wherein the first set of first electrodes and the second set of first electrodes is arranged in an alternating manner.

6. A method for manufacturing a sensor, the method comprises:
providing a first substrate and a second substrate;
printing of a first set of first electrodes and a second set of first electrodes on the first sub strategy;
printing a second electrode extensively on the second substrate;
printing a plurality of force-sensitive elements on at least one of the second electrode or the first set of first electrodes and on the second set of first electrodes;
positioning the first substrate onto the second substrate substantially aligned such that the first electrode is oriented towards the second electrode to obtain the sensor; wherein
the first substrate and the second substrate are provided on a common substrate, further comprising:
assembling by folding the substrate such that the first substrate and the second substrate are substantially aligned; and
cutting the folded substrate to obtain the sensor.

7. The method according to claim 6, wherein
an isolation material is provided on a part of the first set of first electrodes and the second set of first electrodes, which is not covered by the plurality of force-sensitive elements.

8. A method for measuring a force applied to a sensor, the method comprising:
applying a voltage to cause an electric current to flow from a first set of a plurality of first electrodes in a direction substantially perpendicular to a top surface of said first set of the plurality of first electrodes through a first set of a plurality of force-sensitive elements to a second electrode, across the second electrode (A2), and through a second set of the plurality of force-sensitive elements to a second set of the plurality of first electrodes in a direction which is substantially perpendicular to a top surface of said second set of the plurality of first electrodes;
applying the force to the sensor and thus changing an electrical resistance of the first set of the plurality of force-sensitive elements of the sensor and the second set of the plurality of force-sensitive elements of the sensor;
determining, using an electrical measuring device, a change of electrical resistance of the sensor and thereby determining the amount of the applied force.

9. The method according to claim 8, wherein
the determination of the change of electrical resistance of the sensor is obtained by one of a determination of a current-change or determination of a change of electrical resistance of a comparator resistor.

10. The sensor according to claim 2, wherein
the first distance between the plurality of first electrodes is such that the plurality of force-sensitive elements are spaced apart from each other.

11. The sensor according to claim 2, wherein
the plurality of first electrodes are disposed substantially parallel to each other, at an angle to each other or using other geometries.

12. The sensor according to claim 2, wherein
the plurality of first electrodes comprises a first set and a second set of electrodes wherein the first set of first electrodes and the second set of first electrodes is arranged in an alternating manner.

13. The sensor according to claim 4, wherein
the plurality of first electrodes comprises a first set and a second set of electrodes wherein the first set of first electrodes and the second set of first electrodes is arranged in an alternating manner.

14. The sensor according to claim 11, wherein
the plurality of first electrodes comprises a first set and a second set of electrodes wherein the first set of first electrodes and the second set of first electrodes is arranged in an alternating manner.
